(19) United States
(12) Patent Application Publication
(10) Pub. No.: US 2023/0406699 A1
(43) Pub. Date: Dec. 21, 2023

(54) AMMONIA DISSOCIATION PROCESS

(71) Applicants: Khoa Dang Nguyen, Ruislip (GB); Umesh Jain, Richmond, TX (US); Paolo Brunengo, Woking (GB); Elena Stylianou, Greenford (GB); Rohit Khurana, Leatherhead Surrey (GB)

(72) Inventors: Khoa Dang Nguyen, Ruislip (GB); Umesh Jain, Richmond, TX (US); Paolo Brunengo, Woking (GB); Elena Stylianou, Greenford (GB); Rohit Khurana, Leatherhead Surrey (GB)

(73) Assignee: KELLOGG BROWN & ROOT LLC, Houston, TX (US)

(21) Appl. No.: 18/336,927

(22) Filed: Jun. 16, 2023

Related U.S. Application Data
(60) Provisional application No. 63/353,402, filed on Jun. 17, 2022.

(51) Int. Cl. C01B 3/04; B01J 19/24; B01J 15/00; B01J 19/00; B01D 3/32; B01D 3/00; B01D 53/14; B01D 53/18

(52) U.S. Cl. CPC C01B 3/047; B01J 19/2415; B01J 15/005; B01J 19/0013; B01D 3/32; B01D 3/007; B01D 53/1493; B01D 53/18; C01B 2203/1294; C01B 2203/0833; C01B 2203/0883; C01B 2203/0827; C01B 2203/1058; C01B 2203/1064; B01J 2219/00103; B01J 2219/00157; B01D 2257/406; B01D 2252/103; B01D 2256/16; B01D 2256/10

(57) ABSTRACT

A process of dissociating ammonia into a dissociated hydrogen/nitrogen stream in catalyst tubes within a radiant tube furnace and an adiabatic or isothermal unit containing catalyst, along with downstream purification process units to purify the dissociated hydrogen/nitrogen stream into high purity hydrogen product.

### CROSS-REFERENCE TO RELATED APPLICATIONS

This application claims the benefit of U.S. Provisional Application No. 63/353,402, filed Jun. 17, 2022, the contents of which are incorporated herein by reference in their entirety.

### TECHNICAL FIELD

The present invention relates to systems and methods for dissociating ammonia into nitrogen and hydrogen. In examples, the systems and methods may be configured to disassociate ammonia into nitrogen and hydrogen in one or more reactors.

### BACKGROUND

The world is progressing to decarbonization of energy processes; i.e., clean energy. Ammonia has been identified as a most promising carbon-free long-distance energy carrier when ammonia is understood as a carrier of hydrogen. It is expensive to store gaseous hydrogen and to transport it to end users. Hydrogen's high storage and transportation costs are primarily attributed to the expense of using high-pressure tanks and pipelines for containing the gas.

There are growing opportunities and demands for dissociating ammonia back into a hydrogen and nitrogen mixture, and then to use the generated hydrogen as a clean product or fuel. Ammonia can thus be an important as an energy carrier and for producing hydrogen. For example, ammonia can be used as a fuel carrier for the generation of electrical power in regions with few or no fuel sources. Additionally, and alternatively, hydrogen may be transported in pipelines and may be supplied as a clean product and/or fuel to a wide variety of industries. Furthermore, as an energy carrier ammonia may also act as an energy source to even out the fluctuating electricity production from renewable energy technologies such as wind, solar, and hydroelectric power. An advantage of ammonia as an energy carrier is that liquid ammonia is easier to transport and to store, relative to natural gas or hydrogen gas.

Green and blue ammonia can be produced at remote locations where feedstock cost is low or abundant. Green and blue ammonia are produced at remote locations where feedstock cost is low (e.g., natural gas for blue ammonia) or abundant (e.g., wind, solar, hydropower for green ammonia) “Green ammonia” is defined herein as ammonia made by a process that is 100% renewable and carbon free. “Blue ammonia” is defined herein as ammonia produced by a low carbon method, e.g., natural gas stream reforming with carbon capture and underground storage.

It would be desirable to find a productive way of dissociating ammonia (NH₃) into relatively high purity hydrogen (H₂) and nitrogen (N₂), particularly so that the hydrogen can be used as a clean product and/or fuel source.

### SUMMARY

Described herein are examples of an ammonia dissociation process and system that can substantially obviate one or more of the problems due to limitations and disadvantages of the related art.

Additional features and advantages of the examples will be set forth in the description which follows, and in part will be apparent from the description, or may be learned by practice of the described process and/or system. The objectives and other advantages will be realized and attained by the process and/or system particularly pointed out in the written description and claims hereof as well as the appended drawings.

In examples, provided is a process for dissociating ammonia into hydrogen and nitrogen that may include preheating a liquid ammonia feed in a first preheater to produce a preheated liquid ammonia stream while recovering heat from a dissociated hydrogen/nitrogen stream; vaporizing the preheated liquid ammonia feed to produce a vaporized ammonia stream; dissociating at least a portion of the vaporized ammonia stream to produce the dissociated hydrogen/nitrogen stream by feeding the vaporized ammonia stream to a first reactor to produce a reactor effluent; and feeding the reactor effluent to a radiant tube reactor provided in an ammonia dissociation furnace; and feeding a low-carbon fuel to the ammonia dissociation furnace from a tail gas from a pressure swing adsorption, an unpurified mixture product from an ammonia scrubber, the vaporized ammonia stream, or a combination thereof.

In examples, dissociating the vaporized ammonia stream may include contacting the vaporized ammonia stream to one or more catalysts comprising a base metal catalyst, a precious metal based catalyst or a combination thereof. In examples, a base metal catalyst may include a Nickel-based catalyst. In examples, a precious metal based catalyst may include ruthenium.

In examples, feeding the vaporized ammonia stream to the first reactor may include feeding the vaporized ammonia stream to an adiabatic reactor or to an isothermal unit.

In examples, feeding the vaporized ammonia stream to the first reactor may include feeding the vaporized ammonia stream to an isothermal unit configured to recover heat form the dissociated hydrogen/nitrogen stream.

In examples, the process may include recovering heat from a convection section of the ammonia dissociation furnace to heat a boiler feed water stream.

In examples, the process may include recovering heat from a convection section of the ammonia dissociation furnace to generate steam where the steam may be directed to a steam drum. In examples, the steam may be used to heat an ammonia distillation unit downstream of the ammonia dissociation furnace or alternatively exported from the unit. In examples, the process may include using the steam to supply heat for the vaporizing of the preheated liquid ammonia feed.

In examples, the process may include recovering heat from a convection section of the ammonia dissociation furnace to heat an ammonia distillation unit downstream of the ammonia dissociation furnace.

In examples, the process may include preheating at least a portion of the fuel via one or more coils located in a convection section of the ammonia dissociation furnace.

In examples, the process may include feeding a gas turbine exhaust to the ammonia dissociation furnace to supply combustion air to one or more burners of the ammonia dissociation furnace.

In examples, vaporizing the preheated liquid ammonia feed may include recovering heat from the dissociated hydrogen/nitrogen stream before the preheater recovers heat from the dissociated hydrogen/nitrogen stream.

In examples, the process may include feeding the dissociated hydrogen/nitrogen stream to a purification process after the preheater has recovered heat from the dissociated hydrogen/nitrogen stream to produce a hydrogen product stream having a hydrogen concentration ranging from 75 mol % to about 99.99999 mol %.

In examples, disclosed is a process for dissociating ammonia into hydrogen and nitrogen that may include feeding a vaporized ammonia stream to an adiabatic reactor comprising one or more catalysts to dissociate ammonia; feeding an effluent reactor stream of the adiabatic reactor to one or more radiant tubes located in a radiant reactor section of an ammonia dissociation furnace to produce a dissociated hydrogen/nitrogen stream, wherein the ammonia dissociation furnace comprises a convection section; and transferring heat from the convection section of the ammonia dissociation furnace to an ammonia distillation unit.

In examples, the process may include producing steam by recovering heat from the dissociated hydrogen/nitrogen stream.

In examples, the process may include feeding the dissociated hydrogen/nitrogen stream to an ammonia scrubber configured to remove unreacted ammonia from the dissociated hydrogen/nitrogen stream with wash water to produce a hydrogen-nitrogen gas mixture and an aqueous ammonia solution; and feeding the aqueous ammonia solution to the ammonia distillation unit for recovery of unreacted ammonia and of the wash water.

In examples, disclosed is a process for dissociating ammonia into hydrogen and nitrogen that may include dissociating ammonia from a vaporized ammonia stream in isothermal conditions to produce a reactor effluent without temperature change across the reactor, while recovering heat from a dissociated hydrogen/nitrogen stream, and feeding the reactor effluent to a radiant tube reactor to dissociate ammonia present in the reactor effluent to output the dissociated hydrogen/nitrogen stream.

In examples, disclosed is a system for dissociation of ammonia into hydrogen and nitrogen that may include an ammonia dissociation furnace that may include a convection section and a radiant section. The system may include a preheater heat exchanger arranged to receive a liquid ammonia feed and a dissociated hydrogen/nitrogen stream, the preheater heat exchanger configured to transfer heat from the dissociated hydrogen/nitrogen stream to the liquid ammonia feed and produce a preheated ammonia stream. The system may include a vaporizer downstream of the preheater and configured to vaporize the preheated ammonia stream to produce a vaporized ammonia stream. The system may include a first reactor and configured to receive the vaporized ammonia stream, the first reactor including an adiabatic reactor or an isothermal unit. The system may include a radiant tube reactor located in the radiant section and downstream from the first reactor and configured to receive a reactor effluent from the first reactor and to output the dissociated hydrogen/nitrogen stream. The system may include a low-carbon fuel feed to the ammonia dissociation furnace from a pressure swing adsorption, an ammonia scrubber, the vaporizer, or a combination thereof.

In examples, the first reactor may include an adiabatic reactor comprising an inlet condition temperature ranging from about 500° C. to about 750° C., and an outlet condition temperature ranging from about 300 to about 550° C.; or an isothermal unit comprising an inlet condition temperature ranging from about 300° C. to about 650° C., and an outlet condition temperature ranging from about 300 to about 600° C.

The system may include a steam generation section that may include one or more coils in the convection section of the ammonia dissociation furnace configured to recover heat from the ammonia dissociation furnace and utilize the heat in the steam within the process.

In examples, disclosed is a system for dissociation of ammonia into hydrogen and nitrogen that may include an ammonia dissociation furnace that may include a convection section and a radiant reactor section. In examples the system may include an ammonia distillation reboiler section located in the convection section of the ammonia dissociation furnace, the ammonia distillation reboiler section thermally coupled to an ammonia distillation unit and including one or more coils configured to recover heat from the convection section of the ammonia dissociation furnace. The system may include an adiabatic reactor comprising one or more catalysts to dissociate ammonia and a reactor effluent. The system may include one or more radiant tubes located in the radiant reactor section of the ammonia dissociation furnace configured to receive the reactor effluent from the adiabatic reactor and output a dissociated hydrogen/nitrogen stream.

In examples, the system may include a heat exchanger functionally connected to a steam drum and arranged to produce steam by recovering heat from the dissociated hydrogen/nitrogen stream.

In examples, the system may include a gas turbine exhaust feed to one or more burners located in the ammonia dissociation furnace.

In examples, the system may include an ammonia scrubber coupled to the ammonia distillation reboiler section, the ammonia scrubber arranged to receive the dissociated hydrogen/nitrogen stream and configured to remove unreacted ammonia from the dissociated hydrogen/nitrogen stream with wash water to produce a hydrogen-nitrogen gas mixture and an aqueous ammonia solution, wherein the aqueous ammonia solution is directed to the ammonia distillation unit for recovery of an unreacted ammonia and of the wash water.

In examples, disclosed is a system for dissociation of ammonia into hydrogen and nitrogen that may include an isothermal unit and configured to receive a vaporized ammonia stream and to recover heat from a dissociated hydrogen/nitrogen stream, and a radiant tube reactor downstream the isothermal unit configured to receive a reactor effluent from the isothermal unit and to output the dissociated hydrogen/nitrogen stream.

In examples, the isothermal unit may include a reactor cum heat exchanger with an ammonia containing stream inlet condition temperature ranging from about 300° C. to about 650° C., and an outlet condition temperature ranging from about 300 to about 600° C.

In examples, the radiant tube reactor may include one or more radiant tubes located in a radiant reactor section of an ammonia dissociation furnace comprising a convection section.

In examples, one or more of the above discussed systems may include an ammonia scrubber for receiving the dissociated hydrogen/nitrogen stream, the ammonia scrubber configured to remove unreacted ammonia from the dissociated hydrogen/nitrogen stream with wash water to produce a hydrogen-nitrogen gas mixture.

In examples, one or more of the above discussed systems may include a pressure swing adsorption unit configured to receive the hydrogen-nitrogen gas mixture from the ammonia scrubber, the pressure swing adsorption unit configured to purify the hydrogen-nitrogen gas mixture to give a hydrogen product stream having a hydrogen concentration ranging from 75 mol % to 99.99999 mol %.

In examples, the pressure swing adsorption unit may include a flue gas effluent directed to the ammonia dissociation furnace to be used as fuel.

As further illustrated in the examples described in the description that follows, any two or more of the above recited process steps and/or system features may be combined.

### BRIEF DESCRIPTION OF THE DRAWING

FIG. 1 is a schematic block flow diagram of an example of a system and method for dissociating ammonia as described herein with an adiabatic first-stage dissociation process.

FIG. 2 is a schematic block flow diagram of another example of a system and method for dissociating ammonia as described herein with an adiabatic first-stage dissociation process.

FIG. 3 is a schematic block flow diagram of an example of a system and method for dissociation ammonia as described herein implementing an isothermal first-stage dissociation process.

It will be appreciated that the drawings are schematic illustrations, and that the invention is not limited to the design, proportions, or specific equipment shown in the drawings.

### DETAILED DESCRIPTION

In examples, the present disclosure describes a system and process of dissociating ammonia in one or more reactors. In examples, the system and process may dissociate ammonia into a hydrogen and nitrogen. In examples, the system and process may produce a hydrogen product stream. In examples, the system and process may produce a high purity hydrogen product stream.

In examples, hydrogen product stream may have various uses. In examples, a high purity hydrogen product stream may be used in fuel cells. Fuel cells may be used as power generators. In examples, fuel cells may be used to power a vehicle. In examples, fuel cells may be used in power generation stations. In examples, hydrogen product stream may also be used in pipelines. In examples, hydrogen product stream may be used in the steel and cement industries. In examples, hydrogen product stream may be used in industrial plants. In examples, hydrogen product stream may be used as a clean burning fuel in power plants and/or other settings. The process and system described herein may thus aid in the supply of hydrogen product stream for these and other uses.

In examples, the dissociation may occur in one or more reactors. In examples, dissociation of ammonia may occur in the presence of one or more catalysts. In examples, the one or more catalysts may be provided in one or more reactors. In examples, the one or more reactors may include a first reactor and a second reactor. In examples, the second reactor may be downstream the first reactor.

In examples, the first reactor may include an adiabatic reactor or an isothermal unit. In examples, the second reactor may include a radiant tube reactor. In examples, the second reactor may include a down-fired furnace.

In examples, the second reactor may be a radiant section of an ammonia dissociation furnace. In examples, the one or more reactors may include an adiabatic reactor and a down-fired furnace and/or radiant tube reactor. In examples, the one or more reactors may include an isothermal unit and a down-fired furnace and/or radiant tube reactor.

In examples, the system and process may include the generation of steam to be used as heat source in one or more parts of the process and/or in other applications. In examples, steam may be generated by recovering heat from a convection section of the ammonia dissociation furnace. In examples, steam may be generated by recovering heat from a dissociated hydrogen/nitrogen stream produced by the second reactor, e.g., the radiant tube reactor.

In examples, the system and process herein provide for heat recovery to preheat and/or vaporize an ammonia feed. In examples, the energy or heat recovery may be from a dissociated hydrogen/nitrogen stream produced by the second reactor, e.g., the radiant tube reactor.

In examples, the system and process may optionally include a downstream purification process system. In examples, a purification process system may include one or more units to purify the dissociated hydrogen/nitrogen stream into a high purity hydrogen product stream. In examples, the purification process system may be after cooling of the dissociated hydrogen/nitrogen stream caused by the heat recovery to preheat and/or vaporize an ammonia feed. In examples, a purification process may include the use of an ammonia distillation unit. In examples, the process and system as described may provide for heat recovery from an ammonia dissociation furnace to provide heat to an ammonia distillation unit.

In examples, the system or process can have zero direct carbon emissions and be self-sufficient in terms of fuel required for ammonia dissociation. In examples, the system or process may use any number of streams within the process individually as fuel or in combination. For example, clean fuel sources from within the process may be vaporized ammonia, unpurified hydrogen-nitrogen mixture downstream of the ammonia scrubber, rejected gas or tail-gas from the PSA, or a combination thereof. In examples, the system or process may not require the import of natural gas for the ammonia dissociation.

In examples, the system or process can be self-sufficient in terms of hot utility required within the process, minimizing integration with external units and reducing cost associated with external support units. In examples, the heat required for a column reboiler of an ammonia distillation unit can be supplied by steam generated within the process or system from available heat in the ammonia dissociation furnace convection section. In examples, the process or system can make use of heat available in the system and transporting heat to where is needed by the use of steam as the medium. In examples, the heat required for the ammonia distillation unit and/or the reboiler thereof can be supplied directly from heat exchange using a coil in the ammonia dissociation furnace convection section through which coil gasses from the ammonia distillation unit can travel, making direct use of the heat available in the system.

Reference will now be made in detail to examples of the present invention illustrated in the accompanying drawings.

Unless defined otherwise, all technical and scientific terms used herein have the same meaning as is commonly understood by one of skill in the art to which the inventions belong. All patents, patent applications, published applications and publications, websites and other published materials referred to throughout the entire disclosure herein, unless noted otherwise, are incorporated by reference in their entirety. Where there is a plurality of definitions for terms herein, those in this section prevail. Where reference is made to a URL or other such identifier or address, it is understood that such identifiers can change and information on the internet can come and go, but equivalent information can be found by searching the internet. Reference thereto evidences the availability and public dissemination of such information.

As used herein, the singular forms “a,” “an,” and “the” are intended to include the plural forms as well, unless the context clearly indicates otherwise.

As used herein, ranges and quantities can be expressed as “about” a particular value or range. “About” also includes the exact amount. Hence “about 5 percent” means about 5 percent in addition to 5 percent. The term “about” means within typical experimental error for the application or purpose intended.

As used herein, the term “and/or” includes any and all combinations of one or more of the associated listed items.

As used herein, a “combination” refers to any association between two items or among more than two items. The association can be spatial or refer to the use of the two or more items for a common purpose.

The words “comprising” and “comprises” as used throughout the claims, are to be interpreted to mean “including but not limited to” and “includes but not limited to”, respectively.

As used herein, “optional” or “optionally” means that the subsequently described event or circumstance does or does not occur, and that the description includes instances where the event or circumstance occurs and instances where it does not. For example, an optional component in a system means that the component may be present or may not be present in the system.

As used herein, the word “substantially” shall mean “being largely but not wholly that which is specified.”

The terms first, second, third, etc. as used herein can describe various elements, components, regions, layers and/or sections, these elements, components, regions, layers and/or sections should not be limited by these terms. These terms may be only used to distinguish one element, component, region, layer or section from another region, layer, or section. Terms such as “first”, “second”, and other numerical terms when used herein do not imply a sequence or order unless clearly indicated by the context. Thus, a first element, component, region, layer, or section discussed below could be termed a second element, component, region, layer, or section without departing from the teachings of the example embodiments.

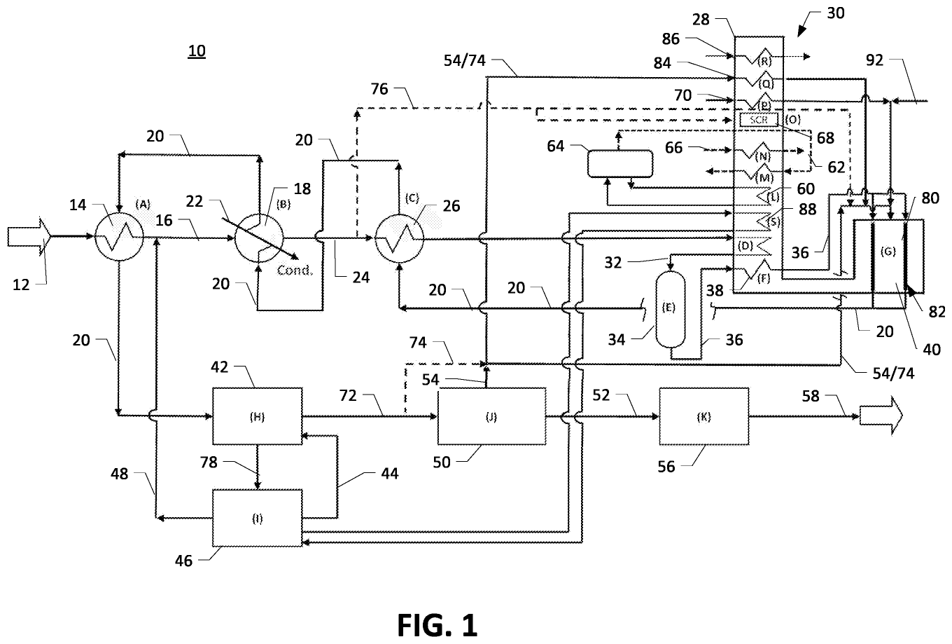

FIG. 1 describes an example of a system 10 for ammonia dissociation. In examples, a liquid ammonia feed 12 may be supplied. In examples, liquid ammonia feed 12 may come from a battery limit (e.g., from an atmospheric storage tank). Other sources could also be used. In examples, liquid ammonia feed may include a high ammonia concentration. In examples, the ammonia concentration in the liquid ammonia feed 12 can range from about 99.5 wt % to about 99.8 wt %. In examples, the balance of the liquid ammonia feed 12 may be water. In examples, the liquid ammonia feed 12 may include a composition including about 99.8 wt % ammonia and 0.2 wt % water.

In examples, the system may include a preheater 14 configured in stage (A) to preheat the liquid ammonia feed 12 to near boiling temperature. In examples, the liquid ammonia feed 12 may be preheated to about 30° C. to about 100° C. to form a preheated liquid ammonia stream 16. In examples, preheater 14 may be any type of heater. In examples, preheater 14 may include a process inter-changer heat exchanger. In examples, the preheating of the liquid ammonia feed 12 in a first preheater 14 to produce a preheated liquid ammonia stream 16 may be done while recovering heat from a dissociated hydrogen/nitrogen stream 20. In examples, the preheating of stage (A) may be carried out using a residual heat from the dissociated hydrogen/nitrogen stream 20 described in more detail later. In examples, preheater 14 may be configured to recover heat from the dissociated hydrogen/nitrogen stream 20. In examples, preheater 14 may be configured to transfer heat from the dissociated hydrogen/nitrogen stream 20 to the liquid ammonia feed 12 to produce preheated liquid ammonia stream 16. In examples, the implementation of preheater 14 the preheating of stage (A) may be carried out using a residual heat from the dissociated hydrogen/nitrogen stream 20 can improve the heat integration of the system and thus provide greater energy efficiency.

In examples, the system may include a vaporizer 18 downstream form the preheater 14. In examples, in stage (B), the preheated liquid ammonia stream 16 from stage (A) may be vaporized in vaporizer 18 to produce a vaporized ammonia stream 24. In examples, vaporizer 18 may be any type of vaporizer. In examples, vaporizer 18 may include heat transfer from the process. In examples, vaporizer 18 may be configured to recover heat from the dissociated hydrogen/nitrogen stream 20. In examples, the vaporizer 18 may vaporize the preheated liquid ammonia stream 16 by transferring heat from and/or cooling the dissociated hydrogen/nitrogen stream 20 and condensing surplus low-pressure steam. In examples, the low-pressure steam may be supplied by the output of superheated steam section 62 stage (M), steam drum 64, the output steam from an ammonia distillation unit 46, and/or from an outside source as stream 22.

In examples, the system may include one or more heating means to further heat the vaporized ammonia stream 24 to produce a heated ammonia vapor stream 32. In examples, the vaporized ammonia stream 24 may be heated further. In examples, in stage (C), further heating of the vaporized ammonia stream 24 may be conducted using a feed/effluent exchanger 26. In examples, a feed/effluent exchanger 26 may be configured to heat the vaporized ammonia stream 24 to a range of about 90° C. to about 500° C. In examples, feed/effluent exchanger 26 may include a heat exchanger. In examples, feed/effluent exchanger 26 may be configured to recover heat from the dissociated hydrogen/nitrogen stream 20. In examples, feed/effluent exchanger 26 may be configured to transfer heat from the dissociated hydrogen/nitrogen stream 20 to vaporized ammonia stream 24.

In examples, the system may include an ammonia dissociation furnace 30. In examples, the ammonia dissociation furnace 30 may be configured with a radiant section 40 for second-stage ammonia dissociation in catalytic dissociation and a convection section 28.

In examples, in stage (D), the vaporized ammonia stream 24 may be heated in the convection section 28 of an ammonia dissociation furnace 30.

In examples, convection section 28 of the ammonia dissociation furnace 30 may include one or more optional components.

In examples, convection section 28 of ammonia dissociation furnace may optionally include a high pressure (up to about 120 bara), medium pressure (up to about 60 bara), or low pressure (e.g., up to about 10 bara) steam generation section 60 (also identified as stage L). In examples, the steam generation section 60 may include one or more coils located in the convection section 28 of the ammonia dissociation furnace 30. In examples, the steam generation section 60 may be configured to recover heat from convection section 28. In examples, the steam generation section 60 may be functionally coupled to a steam drum 64 and used to generate steam at a pressure ranging from about 3 bara to about 120 bara. In examples, using the generated steam as the medium, it may be possible to make use of heat available in the system and to transport the heat to where it may be desirable. In examples, the effluent from the steam generation section 60 and/or an effluent from steam drum 64 may be used to provide heat for an ammonia distillation unit 46 that can be part of a hydrogen purification process as described in more detail later. In examples, the same steam may also be used to provide the steam and/or heat to vaporizer 18 to vaporize the preheating liquid ammonia stream 16. For example, after providing heat to the ammonia distillation unit 46, the same steam may also be used to provide the steam and/or heat to vaporizer 18 to vaporize the preheating liquid ammonia stream 16.

In examples, convection section 28 of ammonia dissociation furnace may optionally include a superheating steam section 62 (also identified as stage M). In examples, a superheating steam section 62 may be functionally coupled to a steam drum 64. For clarity, steam lines in FIG. 1 are depicted by dotted lines. In examples, superheating steam section 62 may include one or more coils in the convection section of the ammonia dissociation furnace 30. In examples, superheating steam section 62 may be configured to recover heat from convection section 28. In examples, the superheating steam section 62 may be configured to superheat steam from 140° C. to about 550° C. In examples, the superheated steam from superheating steam section 62 may be used as a heat source for one or more other components. In examples, the effluent from superheating steam section 62 may be used to provide heat for ammonia distillation unit 46 that can be part of a hydrogen purification process as described in more detail later. Also, in examples, after the ammonia distillation unit 46, the effluent from superheating steam section 62 may be used to provide heat to vaporize the preheated liquid ammonia stream 16 in vaporizer 18. In examples, this can make use of heat available in the system and transporting heat to where it may be desirable by using steam as the medium.

In examples, the process and system can be self-sufficient in terms of hot utility requirement. In examples, the use of the steam from steam drum 64, from the effluent of steam generation section 60, and/or superheated steam from superheating steam section 62, as a heat transporting medium to one or more other components can make the process and system self-sufficient in terms of hot utility requirement.

In examples, convection section 28 of ammonia dissociation furnace may optionally include a boiler feed water stream (BFW) preheat section 66 (also identified as stage N). In examples, BFW preheat section 66 may include one or more coils in the convection section 28 of the ammonia dissociation furnace 30. In examples, BFW preheat section 66 may be configured to recover heat from convection section 28. In examples, BFW preheat section 66 may be configured to heat BFW anywhere from about 130° C. to about 350° C. In examples, the heated BFW may be fed to steam drum 64.

In examples, convection section 28 of ammonia dissociation furnace may optionally include a selective catalytic NOx reduction (SCR) section 68 (also identified a stage O). In examples, SCR section 68 may be configured to inject an ammonia solution atomized by air into NOx containing flue gas generated by ammonia dissociation furnace 30 and contacting and/or exposing the mixture to a catalyst bed configured to react the ammonia with NOx to produce nitrogen gas and water vapor. In this manner, it may be possible to reduce and/or eliminate venting of NOx into the atmosphere. In examples, SCR section 68 may be configured to recover heat from convection section 28. In examples, the ammonia solution injected in SCR section 68 may be derived from a portion of vaporized ammonia stream 24 and/or ammonia vapor 76, for example as shown.

In examples, convection section 28 of ammonia dissociation furnace may optionally include a combustion air preheating section 70 (also identified as stage P). In examples, the combustion air preheating section 70 may include one or more coils for recovering heat into combustion air preheating section 70. In examples, the combustion air 70 may be heating anywhere from about 100 to about 600° C. In examples, the heated combustion air may then be provided to the radiant section 40 of ammonia dissociation furnace 30 as an oxygen source for burning fuel.

In examples, gas turbine exhaust 92 may optionally be imported into system and process 10. In examples, the gas turbine exhaust 92 may be rich in oxygen. In examples, the gas turbine exhaust 92 may thus also be optionally used as combustion air for use in the burners of the radiant section 40 of ammonia dissociation furnace 30 to burn fuel. In examples, the gas turbine exhaust 92 may be fed to the burners of radiant section 40 either separately or as a mixed stream with the heated combustion air from combustion air preheating section 70.

In examples, convection section 28 of ammonia dissociation furnace may optionally include a fuel preheat section 84 (also identified as stage Q). In examples, fuel preheat section 84 may be used to pre-heat one or more of the fuels used for radiant section 40 of ammonia dissociation furnace 30. In examples, as shown, fuel preheat section 84 may be employed to pre-heat at least a portion of fuel from rejected gas or tail gas 54 and portion 74 of hydrogen-nitrogen gas mixture 72 when mixed with rejected gas or tail gas 54. In examples, the fuel preheat section 84 may include one or more coils for recovering heat into preheating one or more fuels. In examples, the fuel may be heated anywhere from about 100 to about 250° C.

In examples, convection section 28 of ammonia dissociation furnace may optionally include a water preheat section 86 (also identified as stage R). In examples, water preheat section 86 may be used to pre-heat water for use as a source of heat (hot utility) outside the facility. In examples, water preheat section 86 may include one or more coils for recovering heat into preheating water.

In examples, convection section 28 of ammonia dissociation furnace may optionally include an ammonia distillation reboiler section 88 (also identified as stage S). In examples, the ammonia distillation reboiler section 88 may be configured to provide heat to the ammonia distillation unit 46, by recovering heat directly from the ammonia dissociation furnace convection section, making the process self-sufficient in terms of hot utility requirement. In examples, the ammonia distillation reboiler section 88 may include one or more coils for recovering heat to use for regeneration in ammonia distillation (step I) in ammonia distillation unit 46. In examples, gases form ammonia distillation unit 46 may be circulated via one or more pipes as shown through the one or more coils in ammonia distillation reboiler section 88 of convection section 28 of the ammonia dissociation furnace 30 to recover heat from convection section 28.

In examples, convection section 28 of ammonia dissociation furnace may include any combination of one or more of the above-mentioned optional components. In examples, convection section 28 of ammonia dissociation furnace may include one or more of the optional components in addition to also including at least stages (D) and (F) described herein. In examples, convection section 28 of ammonia dissociation furnace 30 may include a combination of all of the above components in addition to stages (D) and (F) as illustrated, for example, in FIGS. 1-3. In examples, although all shown as being present in FIGS. 1-3, any combination or sub-combination of any one or more of the optional components in convection section 28 may be present in addition to stages (D) and (F) in any of the examples described with reference to FIGS. 1-3.

In examples, the convection section 28 of an ammonia dissociation furnace 30 may be configured to increase the temperature of the vaporized ammonia stream 24 by about 300° C. to about 600° C. In examples, the vaporized ammonia stream 24 may be further heated to produce a heated ammonia vapor stream 32 first in stage (C) by a feed/effluent exchanger 26 and second in stage (D) in the convection section 28 of an ammonia dissociation furnace 30. In examples, heated ammonia vapor stream 32 may have a temperature ranging from about 500° C. to about 750° C.

In examples, the system may include a first reactor. In examples, the system may include as the first reactor an adiabatic reactor 34. In examples, in stage (E), the system and method may include an adiabatic first-stage dissociation. In examples, in stage (E), the heated ammonia vapor stream 32 may be fed to the adiabatic reactor 34. In examples, the adiabatic reactor 34 may include a reactor. In examples, the reactor may include a catalyst bed. In examples, the adiabatic reactor 34 for the first-stage dissociation, can be loaded with one or more suitable catalysts for the dissociation of ammonia. In examples, in adiabatic reactor 34 the heated ammonia vapor may be exposed to and/or contacted with the one or more catalysts. In examples, the one or more catalysts can be base metals (e.g. Ni, Co, Fe), precious metals (e.g. Ru), or any combination thereof. In examples, the adiabatic reactor 34 may be loaded with a nickel-based catalyst, a ruthenium-based catalyst, or a combination thereof and/or in combination with any other suitable catalyst. In examples, nickel-based catalyst can provide enhanced activity. In examples, ruthenium-based catalyst can provide better conversion and relatively better equilibrium.

In examples, the reactor 34 may be configured so that at least a portion of the ammonia in the vaporized ammonia stream 24 and/or heated ammonia vapor stream 32 is dissociated into hydrogen and nitrogen following reaction (Z):

2NH₃+heat↔3H₂+N₂ catalyst (Z)

In examples, not all the ammonia from vaporized ammonia stream 24 and/or heated ammonia vapor stream 32 is dissociated in adiabatic reactor 34. Accordingly, in examples, the first reactor effluent 36 may contain hydrogen, nitrogen, water, unreacted ammonia vapor or any combination hereof.

The dissociation reaction (Z) is an endothermic reaction. Accordingly, the reaction requires cracking heat. In examples, the cracking heat required may be about 0.65 Gcal/MT, 12% ammonia energy. For purposes of this description, it is assumed that the ΔH298 is 46 kJmol-1NH3. Also, in examples, due to the endothermic nature of the dissociation reaction, the first reactor effluent 36 of adiabatic reactor 34 may have a lower temperature than heated ammonia vapor stream 32 that is fed to adiabatic reactor 34.

In examples, the inlet condition of adiabatic reactor 34 may be from about 20 bara to about 50 bara, for example from 25 bara to about 40 bara. In examples, the inlet pressure may be within any subrange of those recited. In examples, inlet condition of the adiabatic reactor 34 may have a temperature ranging from about 500° C. to about 750° C., for example from about 550° C. to about 675° C. In examples, the inlet temperature may be within any subrange of those recited. In examples, the outlet temperature of reactor 34 may have a temperature ranging from about 300° C. to about 550° C., for example, from about 300° C. to about 500° C. In examples, the outlet temperature may be within any subrange of those recited.

In examples, to convert at least a portion of the ammonia from vaporized ammonia stream 24 and/or heated ammonia vapor stream 32 that remains in first reactor effluent 36, the process and system may include a second stage dissociation. In examples, a second stage dissociation may include the use of a second reactor, as for example described below with reference to radiant section 40 of the ammonia dissociation furnace 30.

In examples, the process herein may include a stage (F) of heating the first reactor effluent 36. In examples, the system may include one or more coils in first reactor effluent heating section 38 of convection section 28 configured to direct the first reactor effluent 36 through convection section 28 of the ammonia dissociation furnace 30 for heating prior to reaching radiant section 40.

In examples, after first reactor effluent 36 is heated in first reactor effluent heating section 38 of the ammonia dissociation furnace 30, it may be fed in stage (G) to a second reactor. In examples, the second reactor may include radiant section 40 of the ammonia dissociation furnace 30 for a second-stage dissociation process.

In examples, radiant section 40 of the ammonia dissociation furnace may include one or more catalyst-filled tubes 80. In examples, catalyst-filled tubes 80 may be arranged in one or more rows 82. In examples, as shown, rows 82 may be vertical rows. In examples, each row 82 may include one or more tubes 80. In examples, the arrangement may be like a harp (not shown).

In examples, inside the one or more catalyst-filled tubes 80, at least some of the ammonia from vaporized ammonia stream 24 and/or heated ammonia vapor stream 32 that remains in first reactor effluent 36 may be dissociated into hydrogen and nitrogen, by a similar reaction mechanism as reaction (Z). In examples, the second stage dissociation process in radiant section 40 may include a “near-isothermal dissociation” where heat is supplied via combustion of one or more fuels, “heat-input dissociation” where heat is supplied via a hot stream, and/or “energy-input dissociation” where heat is provided by electrical energy input.

In examples, the radiant section 40 may include a wide range of possible designs. In examples, radiant section 40 may include a radiant tube reactor, an electrified reactor, or combinations thereof. Other designs may also be implemented alone or in combination. In examples, radiant section 40 may include one or more burners (not shown). In examples, heat for the ammonia dissociation may be provided by burning fuel. In examples, radiant section 40 may include a down-fired furnace, side-fired furnace, a bottom-fired furnace, and/or a combination thereof. In examples, in a down-fired furnace the flame direction is from top of the furnace to bottom.

In examples, heat for the ammonia dissociation furnace 30 and/or convection section 28 may be provided from radiant section 40. In examples, heat for the ammonia dissociation furnace 30 and/or convection section 28 may be provided by combusting fuel, electrical energy input or a combination thereof.

In examples, the tubes 80 of the second-stage dissociation in radiant section 40 can be loaded with one or more catalysts as described for adiabatic reactor 34. In examples, the same or different catalysts may be used for radiant section 40 and adiabatic reactor 34. In examples, the tubes 80 of the second-stage dissociation in radiant section 40 can be loaded with nickel-based and/or ruthenium-based catalyst. Other catalysts may also be used alone or in combination. In examples, in tubes 80 and/or radiant section 40 the ammonia that may still be present in first reactor effluent 36 may be exposed to and/or contacted with the one or more catalysts.

In examples, the inlet pressure condition to tubes 80 may be from about 20 bara to about 50 bara, for example from about 25 bara to about 40 bara. In examples, the inlet pressure may be within any subrange of those recited. In examples, the inlet temperature for radiant tube 80 may be from about 450° C. to about 700° C., for example from about 525° C. to about 675° C. In examples, the inlet temperature may be within any subrange of those recited. In examples, the outlet temperature of the tubes 80 may range from about 500° C. to about 750° C., for example from about 550° C. to about 700° C. In examples, the outlet temperature may be within any subrange of those recited.

In examples, the effluent of radiant section 40 is dissociated hydrogen/nitrogen stream 20. In examples, the dissociated hydrogen/nitrogen stream 20 leaving catalyst tubes 80 of the radiant section 40 may contain hydrogen, nitrogen, water and a few percent of unreacted ammonia vapor.

In examples, heat from the dissociated hydrogen/nitrogen stream 20 from radiant section 40 may be recovered. In examples, as previously discussed the dissociated hydrogen/nitrogen stream 20 may be cooled down by one or more of a feed/effluent exchanger 26 (Stage C), vaporizer 18 (Stage B), and preheater 14 (Stage A).

In examples, the dissociated hydrogen/nitrogen stream 20 may be optionally undergo one or more purification and/or processes as described with reference to stage H to stage K. In examples, the one or more purification processes may be used to produce a high purity hydrogen product stream. In examples, the dissociated hydrogen/nitrogen stream 20 may have been cooled prior to entering a purification process. In examples, as illustrated in FIGS. 1-3, the dissociated hydrogen/nitrogen stream 20 may be fed to a purification process after heat has been recovered to preheat and/or vaporize the ammonia feed.

In examples, in stage H, the dissociated hydrogen/nitrogen stream 20 may be fed to an ammonia scrubber 42. In examples, the dissociated hydrogen/nitrogen stream 20 may be fed to an ammonia scrubber 42 after it has been cooled. In examples, the dissociated hydrogen/nitrogen stream 20 may be fed to an ammonia scrubber 42 after preheater 14 and/or vaporizer 18 have recovered heat from the dissociated hydrogen/nitrogen stream 20. In examples, in ammonia scrubber 42 most of the unreacted ammonia in the dissociated hydrogen/nitrogen stream 20 may be removed by wash water 44. In examples, the ammonia scrubber 42 may include one or more effluents. In examples, an effluent of ammonia scrubber 42 may include an aqueous ammonia solution 78. In examples, an affluent of ammonia scrubber 42 may include a hydrogen-nitrogen gas mixture 72. In examples, ammonia scrubber 42 may include a first effluent of aqueous ammonia solution 78 and a second effluent of hydrogen-nitrogen gas mixture 72.

In examples, at stage I, the aqueous ammonia solution 78 from ammonia scrubber 42 may be sent to an ammonia distillation unit 46. In examples, an ammonia distillation unit 46 may include a distillation column. In examples, heat to ammonia distillation unit 46 may be provided with steam and/or superheated steam from steam drum 64, steam generation section 60, and/or superheated steam section 62 as previously discussed. As previously discussed, it may be possible to make use of heat available in the system and transporting heat to where it may be desirable by using steam as the medium. In examples, heat to ammonia distillation unit 46 may be provided directly from ammonia distillation reboiler section 88 (also identified as stage S), making use of heat available in the system directly. In examples, in ammonia distillation unit 46 any unreacted ammonia 48 in aqueous ammonia solution 78 may be separated from the wash water 44 and recycled to the inlet of vaporizer 18 of stage B. In examples, the unreacted ammonia 48 may be combined with the preheated liquid ammonia stream 16 prior to entering vaporizer 18. The wash water 44 may be sent back to ammonia scrubber 42 of stage H.

In examples, the hydrogen-nitrogen gas mixture 72 leaving ammonia scrubber 42 may contain hydrogen, nitrogen, water and less 200 ppm ammonia. In examples, the hydrogen-nitrogen gas mixture 72 may include an ammonia concentration in the range of about 10 to about 200 ppm. In examples, in stage J, hydrogen-nitrogen gas mixture 72 may be sent to one or more pressure swing adsorption systems, unit 50. In examples, in the pressure swing adsorption unit 50 the hydrogen-nitrogen gas mixture 72 may be purified into a hydrogen product 52. In examples, the hydrogen product 52 may have a hydrogen concentration ranging from 75 mol % to about 99.99999 mol %. In examples, the hydrogen concentration of hydrogen product 52 may be at least about 98 mol %. In examples, the hydrogen concentration of hydrogen product 52 may range from about 98 mol % to about 99.99999 mol %.

In examples, a rejected gas or tail gas 54 as a side product of the pressure swing adsorption unit 50 may be sent to ammonia dissociation furnace 30. In examples, rejected gas or tail gas 54 may be a low-carbon fuel for the ammonia dissociation furnace 30 and radiant section 40. In examples, the rejected gas or tail gas 54 may be directed to radiant section 40 of ammonia dissociation furnace 30. In examples, the rejected gas or tail gas 54 may be used as fuel for radiant section 40 of ammonia dissociation furnace 30.

In examples, heat in the ammonia dissociation furnace 30 and radiant section 40 may be provided by fuel and/or electricity. In examples, the heat is at least partially provided by electricity. In examples, any fuel may be used to provide the heat.

In examples, the process or system as described herein may exhibit zero direct carbon emissions and be self-sufficient in terms of fuel for ammonia dissociation. In examples, a low-carbon fuel generated within the process or system may be used to power the ammonia dissociation furnace 30 and radiant section 40. In examples, the ammonia dissociation furnace 30 and radiant section 40 may use tail gas 54 from pressure swing adsorption 50 as main fuel, enabling the process or system to have zero direct carbon emissions and be self-sufficient in terms of fuel for dissociation. In examples, the ammonia dissociation furnace 30 and radiant section 40 may use at least a portion 74 of the hydrogen-nitrogen gas mixture 72 from ammonia scrubber 42 as low-carbon fuel. In examples, portion 74 of the hydrogen-nitrogen gas mixture 72 may be used as main fuel or to supplement fuel, enabling the process or system to have zero direct carbon emissions and be self-sufficient in terms of fuel for dissociation. In examples, the ammonia dissociation furnace 30 and radiant section 40 may optionally use ammonia vapor 76 from vaporizer 18 and/or a portion of vaporized ammonia stream 24 as low-carbon fuel, for example as main fuel or to supplement fuel, enabling the process or system to have zero direct carbon emissions and be self-sufficient in terms of fuel for dissociation. In examples, any combination of two or more of tail gas 54, hydrogen-nitrogen gas mixture 72, and ammonia vapor 76 may be used as fuel for the ammonia dissociation furnace 30 and radiant section 40. In this manner, in examples, the process or system as described herein may exhibit zero direct carbon emissions and be self-sufficient in terms of fuel for ammonia dissociation. In FIG. 1, portion 74 of hydrogen-nitrogen gas mixture 72 and ammonia vapor 76 from vaporizer 18 and/or as a portion of vaporized ammonia stream 24 are indicated by dashed lines.

In examples, not shown, natural gas may further be imported into the process or system 10 to be used as fuel. In examples, because the system and process can be self-sufficient in terms of fuel for dissociation as described above, it may not require and/or be free of a natural gas feed.

In examples, in stage K, the hydrogen product 52 may be compressed to battery limit required pressure in a compressor 56 to give compressed hydrogen product 58.

It will be appreciated that the process and system 10 as described herein with reference to FIG. 1 includes at least one adiabatic reactor 34 as a first reactor and/or at least one radiant section 40 as a second reactor, but not necessarily both. In examples, if both at least one first reactor or adiabatic reactor 34 and at least one second reactor or radiant section 40 are present, the first reactor, e.g. the adiabatic reactor 34, is provided in sequence before the second reactor or radiant section 40 of ammonia dissociation furnace 30, as schematically illustrated in FIG. 1.

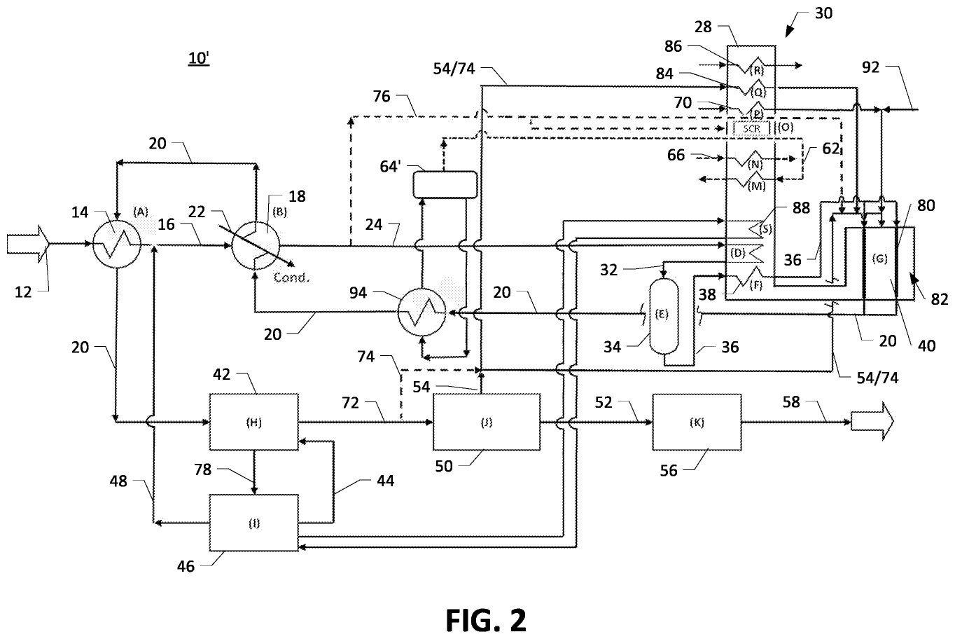

FIG. 2 illustrates an example of system 10′. In examples, system 10′ is similar to system 10 of FIG. 1 with a modification made to the steam generation system. In contrast to FIG. 1, in FIG. 2, the steam generation section 60 (stage L) is removed. For ease of reference, the modified and/or alternative elements are designated with a prime symbol (′). Other corresponding elements have the same reference numerals. In examples, FIG. 2 illustrates a system where the BFW can optionally be preheated in coil N at BFW preheating section 66 before being fed to the steam drum 64′. In examples, steam may be further generated and/or heated by recovering heat from the dissociated hydrogen/nitrogen stream 20 by way of steam heat exchanger 94. In examples, water and/or steam may be circulated through steam heat exchanger 94 to recover heat from dissociated hydrogen/nitrogen stream 20 and then returned to steam drum 64′. In examples, steam optionally may be generated from superheated section 62 in stage M. In examples, it may also be possible to have a combination of both steam generations via superheated section 62 and steam heat exchanger 94. In examples, as previously discussed, the steam may then be used to vaporize ammonia in vaporizer 18. In examples, in this flow-scheme, more heat may be available in the convection section 28 for pre-heating vaporized ammonia stream 24 into heated ammonia vapor stream 32. In examples, in this flow-scheme, feed/effluent exchanger 26 may be omitted. In examples, feed/effluent exchanger 26 may be replaced by steam heat exchanger 94.

In examples, the additional available heat may be used for providing heat to ammonia distillation unit 46 at stage (I). In examples, the additional available heat may be recovered in convection section 28 of ammonia dissociation furnace 30 by including the ammonia distillation reboiler section 88 (also identified as stage S). In examples, the ammonia distillation reboiler section 88 may be configured to provide heat to the ammonia distillation unit 46 as previously described. In examples, the ammonia distillation reboiler section 88 may include one or more coils for recovering heat to use for regeneration in ammonia distillation (step I) in ammonia distillation unit 46 by circulating gases from the ammonia distillation unit 46 through the one or more coils.

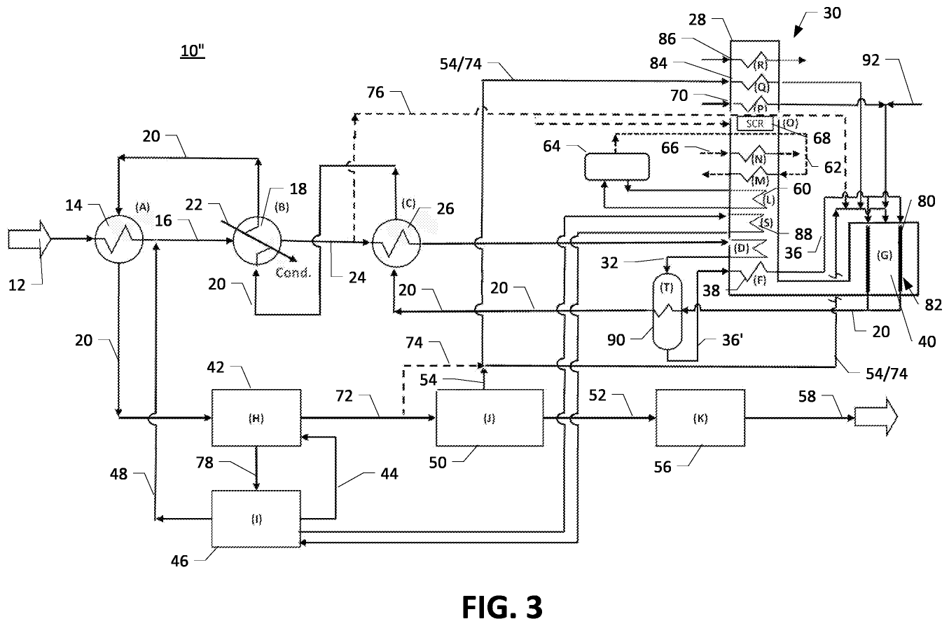

In examples, it may be possible to replace adiabatic process with an isothermal process whereby the ammonia dissociation reaction occurs with little or no temperature change, supported by heat input. In examples, ammonia from a vaporized ammonia stream may be dissociated in isothermal conditions while recovering heat from a dissociated hydrogen/nitrogen stream. FIG. 3 illustrates an example of a system 10″. In examples, system 10″ is similar to system 10 of FIG. 1 and to system 10′ of FIG. 2 with a modification relating to the first reactor. In examples, the modification relates to the adiabatic reactor 34.

As previously explained, ammonia cracking to hydrogen and nitrogen is an equilibrium based endothermic process. In examples, the reaction (Z) can be favored at high temperature. In examples, as also previously discussed, the outlet temperature of the tubes 80 of radiant section 40 of the ammonia dissociation furnace 30 may have a high temperature that can range from about 500° C. to about 750° C., for example from about 550° C. to about 700° C. In examples, this heat can be utilized for isothermal ammonia dissociation or cracking reaction.

In examples, the isothermal ammonia dissociation or cracking of ammonia contained in vaporized ammonia stream 24 and/or heated ammonia vapor stream 32 may be performed in isothermal unit 90 as a first reactor. In examples, isothermal unit 90 may include a reactor cum heat exchanger. In examples, the reactor cum heat exchanger may include a catalyst bed with one or more catalysts for ammonia dissociation. In examples, in isothermal unit 90 the from vaporized ammonia stream 24 and/or heated ammonia vapor stream 32 may be exposed to and/or contacted with the one or more catalysts. In examples, one or more catalysts as previously described with reference to adiabatic reactor 34 may be used in isothermal unit 90.

In examples, not all the ammonia from vaporized ammonia stream 24 and/or heated ammonia vapor stream 32 is dissociated in isothermal unit 90. In examples, similarly to adiabatic reactor 34, the isothermal unit 90, is preferably provided in sequence before the second reactor, i.e. the radiant section 40, as schematically illustrated in FIG. 3. In examples, as illustrated, the first reactor effluent 36′ of isothermal unit 90 may be fed to radiant section 40 for a second stage dissociation. In examples, as previously described, first reactor effluent 36′ may be heated in first reactor effluent heating section 38 of convection section 28. In examples, to convert at least a portion of the ammonia from vaporized ammonia stream 24 and/or heated ammonia vapor stream 32 that remains in first reactor effluent 36′, the process and system may include the use of a second reactor, as for example described herein with reference to radiant section 40 of the ammonia dissociation furnace 30.

In examples, the inlet condition of isothermal unit 90 may be from about 20 bara to about 50 bara. In examples, the inlet pressure may be within any subrange of 20 bara to 20 bara. In examples, inlet condition of isothermal unit 90 may have a temperature ranging from about 300° C. to about 600° C. In examples, the inlet temperature may be within any subrange of 300° C. to 600° C. In examples, the outlet temperature of isothermal unit 90 may have a temperature ranging from about 300° C. to about 600° C. In examples, the outlet temperature may be within any subrange of 300° C. to 600° C. In examples, the inlet temperature may be 300° C. and the outlet temperature may be 600° C. In examples, the inlet temperature may be 500° C. and the outlet temperature may be 500° C.

In examples, the temperature for ammonia feed to the isothermal unit can remain nearly constant across the catalyst bed because heat can be constantly provided by the other side of the reactor-exchanger. In examples, heat may be provided from the dissociated hydrogen/nitrogen stream 20 exiting the radiant section 40 of ammonia dissociation furnace 30.

In examples, by implementing an isothermal process, it may be possible to improve the utilization of and/or simply the process to utilize the ammonia cracking heat. In examples, the implementation of an isothermal process as described may improve the utilization of high-grade heat (i.e. high temperature and high flux heat), such as, for example, fuel generated the heat from ammonia dissociation furnace 30. In examples, the isothermal process may increase ammonia to hydrogen conversion as compared to the adiabatic process described earlier. In examples, because of constant high temperature—which does not reduce across the catalyst bed like in the adiabatic reactor, higher conversion may be obtained for hydrogen formation in the isothermal unit-exchanger. In examples, the isothermal process may have a lower but constant operating temperature than the adiabatic process thus potentially lowering operating costs and improve equipment reliability.

In examples, the system and process as described herein may provide one or more advantages. In examples, the system and process can provide a method to extract hydrogen from ammonia. In examples, the system and process may provide a simplified and/or low-cost flow sheet design. In examples, the system and process as described can provide high product yield and high overall energy efficiency. In examples, the system and method may take advantage of proven process systems and equipment design. In examples, compared to existing technology that is often limited to a relatively small scale (≤5 metric tons per day), the system and process described herein can be large scale (≥300-8500 MTPD ammonia throughput). In examples, the system and process as described can be self-sufficient with respect to energy used for the dissociation of ammonia. In examples, the system and process as described can be powered by electricity and/or fuel. In examples, the system and process as described can be at least in part self-sufficient with respect to energy used for the dissociation of ammonia. In examples, compared to existing technology, the operating pressures can be higher and operating temperatures can be lower. In examples, the better utilization of high-grade heat in the process and system as described can result in higher energy efficiency as compared to existing technology.

In the foregoing specification, the invention has been described with reference to examples thereof. However, the specification is to be regarded in an illustrative rather than a restrictive sense. For example, equipment, reactors, exchangers, furnaces, sections, process streams, processes, reactants, catalysts, products, and operating conditions falling within the claimed or disclosed parameters, but not specifically identified or tried in a particular example, are expected to be within the scope of this invention.

The present invention may be practiced in the absence of an element not disclosed. In addition, the present invention may suitably comprise, consist or consist essentially of the elements disclosed. For instance, there may be provided a process for dissociation of ammonia into hydrogen and nitrogen, where the process comprises, consists essentially of, or consists of feeding ammonia vapor into a reactor procedure, where the reactor procedure is selected from the group consisting of adiabatic dissociation in a reactor comprising a catalyst, dissociation in a radiant tube reactor comprising radiant tubes comprising a catalyst, and a combination of the two, and the process further comprises, consists essentially of, or consists of producing a hydrogen product stream.

There may be further provided a system for dissociation of ammonia into hydrogen and nitrogen, where the system comprises, consists essentially of, or consists of a preheater receiving liquid ammonia and configured to heat the liquid ammonia to give a heated ammonia stream, a vaporizer for receiving the heated ammonia stream and configured to vaporize the ammonia, a feed/effluent exchanger for receiving the vaporized ammonia and configured to heat the vaporized ammonia, a reactor for receiving the heated, vaporized ammonia, where the reactor is selected from the group consisting of an adiabatic dissociation reactor comprising a catalyst, a dissociation reactor comprising radiant tubes comprising a catalyst, and a combination thereof, where the system also comprises, consists essentially of, or consists of a hydrogen product stream drawn from the reactor.

We claim:

1. A process for dissociating ammonia into hydrogen and nitrogen, comprising:
preheating a liquid ammonia feed in a first preheater to produce a preheated liquid ammonia stream while recovering heat from a dissociated hydrogen/nitrogen stream;
vaporizing the preheated liquid ammonia feed to produce a vaporized ammonia stream;
dissociating at least a portion of the vaporized ammonia stream to produce the dissociated hydrogen/nitrogen stream by:
feeding the vaporized ammonia stream to a first reactor to produce a reactor effluent; and
feeding the reactor effluent to a radiant tube reactor provided in an ammonia dissociation furnace; and
feeding a low-carbon fuel to the ammonia dissociation furnace from a tail gas from a pressure swing adsorption, an unpurified mixture product from an ammonia scrubber, the vaporized ammonia stream, or a combination thereof.

2. The process of claim 1, wherein dissociating the vaporized ammonia stream further comprises contacting the vaporized ammonia stream to one or more catalysts comprising a nickel-based catalyst, a ruthenium-based catalyst, or a combination thereof.

3. The process of claim 1, where feeding the vaporized ammonia stream to the first reactor further comprises feeding the vaporized ammonia stream to an adiabatic reactor or to an isothermal unit.

4. The process of claim 1, where feeding the vaporized ammonia stream to the first reactor further comprises feeding the vaporized ammonia stream to an isothermal unit configured to recover heat form the dissociated hydrogen/nitrogen stream.

5. The process of claim 1, further comprising recovering heat from a convection section of the ammonia dissociation furnace to heat a boiler feed water stream.

6. The process of claim 8, further comprising producing steam by recovering heat from a convection section of an ammonia dissociation furnace.

7. The process of claim 6, further comprising using the steam to supply heat for the vaporizing of the preheated liquid ammonia feed.

8. The process of claim 1, further comprising recovering heat from a convection section of the ammonia dissociation furnace to heat an ammonia distillation unit downstream of the ammonia dissociation furnace.

9. The process of claim 1, further comprising providing heat to the ammonia dissociation furnace by combusting fuel.

10. The process of claim 9, further comprising preheating at least a portion of the fuel via one or more coils located in a convection section of the ammonia dissociation furnace.

11. The process of claim 1, further comprising feeding a gas turbine exhaust to the ammonia dissociation furnace to supply combustion air to one or more burners of the ammonia dissociation furnace.

12. The process of claim 1, wherein vaporizing the preheated liquid ammonia feed comprises recovering heat from the dissociated hydrogen/nitrogen stream before the preheater recovers heat from the dissociated hydrogen/nitrogen stream.

13. The process of claim 1, further comprising feeding the dissociated hydrogen/nitrogen stream to a purification process after the preheater has recovered heat from the dissociated hydrogen/nitrogen stream to produce a hydrogen product stream having a hydrogen concentration ranging from 75 mol % to about 99.99999 mol %.

14. A system for dissociation of ammonia into hydrogen and nitrogen comprising:
an ammonia dissociation furnace comprising a convection section and a radiant section;
a preheater heat exchanger arranged to receive a liquid ammonia feed and a dissociated hydrogen/nitrogen stream, the preheater heat exchanger configured to transfer heat from the dissociated hydrogen/nitrogen stream to the liquid ammonia feed and produce a preheated ammonia stream;
a vaporizer downstream of the preheater and configured to vaporize the preheated ammonia stream to produce a vaporized ammonia stream;
a first reactor and configured to receive the vaporized ammonia stream, the first reactor comprising an adiabatic reactor or an isothermal unit;
a radiant tube reactor located in the radiant section and downstream from the first reactor and configured to receive a reactor effluent from the first reactor and to output the dissociated hydrogen/nitrogen stream; and
a low-carbon fuel feed to the ammonia dissociation furnace from a pressure swing adsorption, an ammonia scrubber, the vaporizer, or a combination thereof.

15. The system of claim 14, the first reactor comprising:
an adiabatic reactor comprising an inlet condition temperature ranging from about 500° C. to about 750° C., and an outlet condition temperature ranging from about 300 to about 550° C.; or
an isothermal unit comprising an inlet condition temperature ranging from about 300° C. to about 600° C., and an outlet condition temperature ranging from about 300 to about 600° C.

16. The system of claim 14, the first reactor comprising: a steam generation section comprising one or more coils in the convection section of the ammonia dissociation furnace configured to recover heat from the ammonia dissociation furnace.

17. A system for dissociation of ammonia into hydrogen and nitrogen comprising:
an ammonia dissociation furnace comprising a convection section and a radiant reactor section;
an ammonia distillation reboiler section located in the convection section of the ammonia dissociation furnace, the ammonia distillation reboiler section thermally coupled to an ammonia distillation unit and comprising one or more coils configured to recover heat from the convection section of the ammonia dissociation furnace;
an adiabatic reactor comprising one or more catalysts to dissociate ammonia and a reactor effluent;
one or more radiant tubes located in the radiant reactor section of the ammonia dissociation furnace configured to receive the reactor effluent from the adiabatic reactor and output a dissociated hydrogen/nitrogen stream.

18. The system of claim 17, further comprising a heat exchanger functionally connected to a steam drum and arranged to produce steam by recovering heat from the dissociated hydrogen/nitrogen stream.

19. The system of claim 17, further comprising a gas turbine exhaust feed to one or more burners located in the ammonia dissociation furnace.

20. The system of claim 17, further comprising an ammonia scrubber coupled to the ammonia distillation reboiler section, the ammonia scrubber arranged to receive the dissociated hydrogen/nitrogen stream and configured to remove unreacted ammonia from the dissociated hydrogen/nitrogen stream with wash water to produce a hydrogen-nitrogen gas mixture and an aqueous ammonia solution, wherein the aqueous ammonia solution is directed to the ammonia distillation unit for recovery of an unreacted ammonia and of the wash water.

21. A system for dissociation of ammonia into hydrogen and nitrogen comprising:
an isothermal unit and configured to receive a vaporized ammonia stream and to recover heat from a dissociated hydrogen/nitrogen stream; and
a radiant tube reactor downstream the isothermal unit configured to receive a reactor effluent from the isothermal unit and to output the dissociated hydrogen/nitrogen stream.

22. A process for dissociating ammonia into hydrogen and nitrogen, comprising:
feeding a vaporized ammonia stream to an adiabatic reactor comprising one or more catalysts to dissociate ammonia;
feeding an effluent reactor stream of the adiabatic reactor to one or more radiant tubes located in a radiant reactor section of an ammonia dissociation furnace to produce a dissociated hydrogen/nitrogen stream, wherein the ammonia dissociation furnace comprises a convection section; and
transferring heat from the convection section of the ammonia dissociation furnace to an ammonia distillation unit.

23. The process of claim 22, further comprising producing steam by recovering heat from the dissociated hydrogen/nitrogen stream.

24. The process of claim 22, further comprising:
feeding the dissociated hydrogen/nitrogen stream to an ammonia scrubber configured to remove unreacted ammonia from the dissociated hydrogen/nitrogen stream with wash water to produce a hydrogen-nitrogen gas mixture and an aqueous ammonia solution; and
feeding the aqueous ammonia solution to the ammonia distillation unit for recovery of unreacted ammonia and of the wash water.

25. A process for dissociating ammonia into hydrogen and nitrogen, comprising:
dissociating ammonia from a vaporized ammonia stream in isothermal conditions to produce a reactor effluent while recovering heat from a dissociated hydrogen/nitrogen stream; and
feeding the reactor effluent to a radiant tube reactor to dissociate ammonia present in the reactor effluent to output the dissociated hydrogen/nitrogen stream.
